(19) United States
(12) Patent Application Publication
(10) Pub. No.: US 2026/0114673 A1
(43) Pub. Date: Apr. 30, 2026

(54) AUTOMATIC COOKING APPARATUS

(71) Applicant: TECHMAGIC INC., Tokyo (JP)

(72) Inventor: Shohei MAWATARI, Tokyo (JP)

(21) Appl. No.: 19/150,911

(22) PCT Filed: Jun. 5, 2024
(86) PCT No.: PCT/JP2024/020531

§ 371 Date: Jul. 25, 2025

(30) Foreign Application Priority Data
Jun. 5, 2023 (JP) 2023-092292

(51) Int. Cl. A47J 43/046; A47J 36/34; A47J 43/07; A47J 43/08; A47J 44/00; A47L 15/00

(52) U.S. Cl. CPC A47J 43/046; A47J 36/34; A47J 43/0722; A47J 43/0727; A47J 43/085; A47J 44/00; A47L 15/0097

(57) ABSTRACT

Provided is an automatic cooking apparatus capable of providing dishes from a variety of menus. An automatic cooking apparatus of an embodiment of the present invention includes: a bottomed cylindrical cooking container; and a container holding unit configured to hold the cooking container, the automatic cooking apparatus being configured to perform, at a minimum, agitation and cooking of an ingredient contained in the cooking container, in which the cooking container includes an agitation member configured to agitate the ingredient, the container holding unit includes a container rotation mechanism configured to cause the cooking container to rotate around a container rotation shaft, and when a motional state of the cooking container including a rotational direction, a rotational speed, or a stationary state is a first motional state, the agitation member is allowed to take a second motional state different from the first motional state of the cooking container.

### RELATED APPLICATIONS

The present application is a National Phase of International Application No. PCT/JP2024/020531 filed Jun. 5, 2024, which claims priority to Japanese Application No. 2023-092292, filed Jun. 5, 2023.

### TECHNICAL FIELD

The present invention relates to an automatic cooking apparatus, and more particularly, to an automatic cooking apparatus that performs, at a minimum, agitation and cooking of ingredients contained in a cooking container.

### BACKGROUND ART

In recent years, in the food and beverage industry, automation of cooking operations has been advancing because of the various circumstances concerning the securing of cooks, the maintenance of cooking skills, and the improvement of the cooking environment.

As an automatic cooking apparatus that automates the cooking operation, a technology as disclosed in Patent Literature 1 has been proposed.

In the automatic cooking apparatus described in Patent Literature 1 described above, the posture of a deep pot is changed to any one of postures including an ingredient receiving posture for having the deep pot receive ingredients, a cooking posture for having the deep pot rotate and thereby agitate the ingredients, a dishing-up posture for having the deep pot face downward to a dish, and a washing posture in which the pot is washed.

### CITATION LIST

### Patent Literature

PTL 1: Japanese Patent Application Laid-Open No. 2022-175791

### SUMMARY OF INVENTION

### Technical Problem

In the automatic cooking apparatus of Patent Literature 1 described above, the posture of the deep pot can be changed to any one of the ingredient receiving posture, the cooking posture, the dishing-up posture, and the washing posture, so that automatic cooking that includes washing of the deep pot can be performed. However, there are various problems concerning the use of the automatic cooking apparatus to provide dishes from a variety of menus. For example, in order to cook stir-fried vegetables, it is necessary to raise the heating temperature, heat the ingredients well, and then agitate the ingredients in a deep pot so that the ingredients are not burnt onto the pot. Furthermore, for example, in the case of cooking fried rice, in order to achieve a cooking motion similar to the motion of a cook shaking the pot, this motion thereby frying the rice into a crispy state, it is required to agitate the rice to let the grains of the rice move as if they are dancing in the deep pot. In addition, when the heating temperature is raised in the deep pot, an improvement is also required in a washing method for removing residues inside the deep pot.

Accordingly, the present invention has been made in order to solve the problems of the conventional technology as described above, and therefore an object of the present invention is to provide an automatic cooking apparatus capable of providing dishes from a variety of menus.

### Solution to Problem

The above-mentioned object of the present invention can be achieved by the following configuration. Specifically, an automatic cooking apparatus of a first aspect of the present invention includes: a bottomed cylindrical cooking container; and a container holding unit configured to hold the cooking container, the automatic cooking apparatus being configured to perform, at a minimum, agitation and cooking of an ingredient contained in the cooking container, wherein:
the cooking container includes an agitation member configured to agitate the ingredient.

And the container holding unit includes a container rotation mechanism configured to cause the cooking container to rotate around a container rotation shaft; the agitation member is driven from the bottom surface of the cooking container; when a motional state of the cooking container including a rotational direction, a rotational speed, or a stationary state is a first motional state, the agitation member is allowed to take a second motional state that does not depend on the first motion state of the cooking container.

And the container holding unit includes an agitation member drive mechanism configured to rotationally drive the agitation member, and the agitation member drive mechanism is capable of setting the motional state of the agitation member to the second motional state different from the first movement state of the cooking container by the container rotation mechanism; and when an operational state of the cooking container is a right rotation, a left rotation, or a stationary state, the agitation member drive mechanism is capable of setting an operational state of the agitation member to any state of a right rotation, a left rotation, or a stationary state.

An automatic cooking apparatus according to a second aspect of the present invention is the automatic cooking apparatus according to the first aspect, wherein the agitation member further includes a scraping member configured to scrape food cooked by the automatic cooking apparatus in accordance with an operational state of the agitation member and/or the cooking container.

An automatic cooking apparatus according to a third aspect of the present invention is the automatic cooking apparatus according to the first aspect, wherein a posture of the cooking container is allowed to be changed to any one of postures including:
(1) an ingredient receiving posture for having the cooking container receive the ingredient;
(2) a cooking posture for having the cooking container be rotated by the container rotation mechanism to cook the ingredient;
(3) a dishing-up posture in which the cooking container is caused to face downward to a dishing-up container; and
(4) a washing posture for washing the cooking container with an opening side of the cooking container facing downward.

An automatic cooking apparatus according to a fourth aspect of the present invention is the automatic cooking apparatus according to the third aspect, wherein when the cooking container is in the washing posture, the cooking container is washed by bringing a scraper into contact with an inner surface of the cooking container.

An automatic cooking apparatus according to a fifth aspect of the present invention is the automatic cooking apparatus according to the fourth aspect, wherein when the cooking container is in the washing posture, the cooking container is placed in at least one washing state out of: a washing state where the scraper is brought into elastic contact with the inner surface of the cooking container; a washing state where the scraper is driven in a state where the scraper is in contact with the inner surface of the cooking container; and a washing state where the cooking container is caused to rotate in a state where the scraper is in contact with the inner surface of the cooking container.

### Advantageous Effects of Invention

According to the automatic cooking apparatus of the first aspect of the present invention including: a bottomed cylindrical cooking container; and a container holding unit configured to hold the cooking container, the automatic cooking apparatus being configured to perform, at a minimum, agitation and cooking of an ingredient contained in the cooking container, the cooking container includes an agitation member configured to agitate the ingredient, the container holding unit includes a container rotation mechanism configured to cause the cooking container to rotate around a container rotation shaft, and when a motional state of the cooking container including a rotational direction, a rotational speed, or a stationary state is a first motional state, the agitation member is allowed to take a second motional state different from the first motional state of the cooking container, so that the ingredient can be appropriately agitated according to the menu. For example, in order to cook stir-fried vegetables, it is possible to raise the heating temperature, heat ingredients well, and then agitate the ingredients in the cooking container so that the ingredients are not burnt onto the container. Furthermore, for example, in the case of cooking fried rice, by appropriately setting the first motional state of the cooking container and the second motional state of the agitation member in order to fry the rice into a crispy state, it is possible to achieve a cooking motion similar to the motion of a cook shaking a pot, and to agitate the rice to let the grains of the rice move as if they are dancing in the cooking container. Accordingly, it becomes possible to provide the automatic cooking apparatus capable of providing dishes from a variety of menus.

And according to the automatic cooking apparatus of the first aspect of the present invention, the container holding unit includes an agitation member drive mechanism configured to rotationally drive the agitation member, and the agitation member drive mechanism is capable of setting the motional state of the agitation member to the second motional state different from the first motional state of the cooking container by the container rotation mechanism. This allows the cooking container to be rotated around the container rotation shaft by the container rotation mechanism, while allowing the agitation member drive mechanism to freely set the operational state of the agitation member, so that appropriate agitation of ingredients in accordance with a menu can be achieved by a simple mechanism.

And according to the automatic cooking apparatus of the first aspect of the present invention, when the operational state of the cooking container is a right rotation, a left rotation, or a stationary state, the agitation member drive mechanism is capable of setting the operational state of the agitation member to any state of a right rotation, a left rotation, or a stationary state. Thus, this allows the agitation member drive mechanism to freely set the operational state of the agitation member without depending on the operational state of the cooking container by the container rotation mechanism, so that appropriate agitation of ingredients is easily set in accordance with a menu.

According to the automatic cooking apparatus of the second aspect of the present invention, the agitation member further includes a scraping member configured to scrape food cooked by the automatic cooking apparatus in accordance with the operational state of the agitation member and/or the cooking container. This makes it possible to automate even the process of dishing up the food that is cooked by the automatic cooking apparatus into a dishing-up container. Moreover, according to the automatic cooking apparatus of the present embodiment, the automatic dishing-up can be realized by a simple mechanism of adding only a scraping member to the agitation member.

According to the automatic cooking apparatus of the third aspect of the present invention, the posture of the cooking container is allowed to be changed to any one of postures including:
(1) an ingredient receiving posture for having the cooking container receive the ingredient;
(2) a cooking posture for having the cooking container be rotated by the container rotation mechanism to cook the ingredient;
(3) a dishing-up posture in which the cooking container is caused to face downward to a dishing-up container; and
(4) a washing posture for washing the cooking container with an opening side of the cooking container facing downward.

This configuration makes it possible to appropriately automate all the steps, which include receiving the ingredient, cooking, dishing-up, and washing.

According to the automatic cooking apparatus of the fourth aspect of the present invention, when the cooking container is in the washing posture, the cooking container is washed by bringing a scraper into contact with an inner surface of the cooking container. This configuration makes it possible to cleanly wash off, at the time of washing, even the residues burnt onto the inner surface of the cooking container. For example, when the heating temperature is raised in the cooking container, although there may be a case where ingredients being burnt onto the inside of the cooking container occurs, it is possible to wash off the burnt residues by the scraper.

According to the automatic cooking apparatus of the fifth aspect of the present invention, when the cooking container is in the washing posture, the cooking container is placed in at least one washing state out of: a washing state where the scraper is brought into elastic contact with the inner surface of the cooking container; a washing state where the scraper is driven in a state where the scraper is in contact with the inner surface of the cooking container; and a washing state where the cooking container is caused to rotate in a state where the scraper is in contact with the inner surface of the cooking container. This makes it possible to wash off the residues on the cooking container more effectively. For example, since the scraper is brought into elastic contact with the inner surface of the cooking container, the force of pushing the scraper against the inner surface of the cooking container can be adjusted. Thus, it is possible to prevent such failure as the scraper being pushed against the cooking container with an excessive force during washing. Furthermore, for example, by driving the scraper in a state of being in contact with the inner surface of the cooking container, it is possible to appropriately scrape off the residues on the inner surface of the cooking container by using the scraper. Furthermore, since the cooking container is caused to rotate in a state in which the scraper is in contact with the inner surface of the cooking container, the combined use of the function of the container rotation mechanism, without requiring an additional mechanism, makes it possible to scrape off residues on the inner surface of the cooking container with the scraper.

### BRIEF DESCRIPTION OF DRAWINGS

FIG. 1 is a right perspective view of an automatic cooking apparatus 100 according to a first embodiment of the present invention.

FIG. 2 is a rear left perspective view of the automatic cooking apparatus 100 illustrated in FIG. 1.

FIG. 3 is a rear left perspective view of the automatic cooking apparatus 100 illustrated in FIG. 1 in a cooking posture.

FIG. 4 is a left perspective view of the automatic cooking apparatus 100 illustrated in FIG. 1 in a dishing-up posture.

FIG. 5 is a rear left perspective view of the automatic cooking apparatus 100 illustrated in FIG. 1 in a washing posture.

FIG. 6 is a rear left perspective view of the automatic cooking apparatus 100 illustrated in FIG. 1 during washing.

FIG. 7 is a perspective view of a cooking container 110 of the automatic cooking apparatus 100 illustrated in FIG. 1.

FIG. 8A to FIG. 8D include elevation views of an agitation member 120 of the automatic cooking apparatus 100 illustrated in FIG. 1.

FIG. 9 is a rear-side cross-sectional view of the automatic cooking apparatus 100 illustrated in FIG. 1.

FIG. 10 is a rear-side partial cross-sectional view of the automatic cooking apparatus 100 illustrated in FIG. 1.

FIG. 11 is a rear-side partial cross-sectional view of the automatic cooking apparatus 100 illustrated in FIG. 1.

FIG. 12 is a cross-sectional view of a washing unit 160 of the automatic cooking apparatus 100 illustrated in FIG. 1.

FIG. 13 is a left-side cross-sectional view of the washing unit 160 of the automatic cooking apparatus 100 illustrated in FIG. 1.

FIG. 14 is a system configuration diagram of the automatic cooking apparatus 100 illustrated in FIG. 1.

FIG. 15 shows a first cooking example of the automatic cooking apparatus 100 illustrated in FIG. 1.

FIG. 16 shows a second cooking example of the automatic cooking apparatus 100 illustrated in FIG. 1.

FIG. 17 is a perspective view of a cooking container 110 of an automatic cooking apparatus 100 according to a second embodiment of the present invention.

FIG. 18 shows a cooking example of the automatic cooking apparatus 100 illustrated in FIG. 17.

FIG. 19 shows a first dishing-up operation example of the automatic cooking apparatus 100 illustrated in FIG. 17.

FIG. 20 shows a second dishing-up operation example of the automatic cooking apparatus 100 illustrated in FIG. 17.

### DESCRIPTION OF EMBODIMENTS

Hereinafter, an automatic cooking apparatus according to an embodiment of the present invention will be described with reference to the drawings. However, the following embodiments will exemplify an automatic cooking apparatus for embodying the technical idea of the present invention, and the present invention is not limited thereto. The following embodiments may be equally applied to other embodiments included in the scope of the patent claims. In the following description, for convenience, expressions such as upper and lower, front and rear, and left and right are used, but these expressions are based on directions illustrated in the corresponding drawings, and are merely descriptions of directions in a state illustrated in the corresponding drawings. It should be noted that in a case where the position or the posture of a movable portion changes from the state in the drawing, the direction after the change may, of course, be different from the drawing illustrating a stationary state. In addition, expressions such as “right rotation” and “left rotation” are used to describe the rotational direction of a cooking container and an agitation member, and these directions are all defined based on a view from the opening side of the cooking container.

### First Embodiment

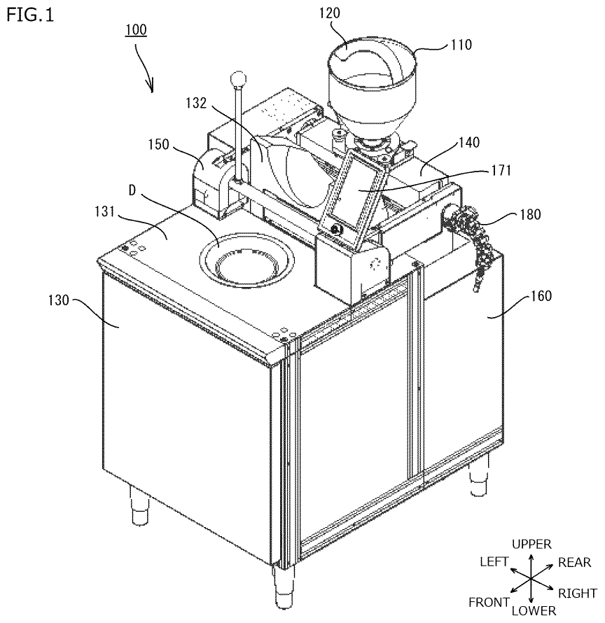

An automatic cooking apparatus according to a first embodiment of the present invention will be described with reference to FIGS. 1 to 16.

### 1. Outline of Automatic Cooking Apparatus 100

First, an outline of an automatic cooking apparatus 100 and a procedure of automatic cooking by the automatic cooking apparatus 100 will be described with reference to FIGS. 1 to 6.

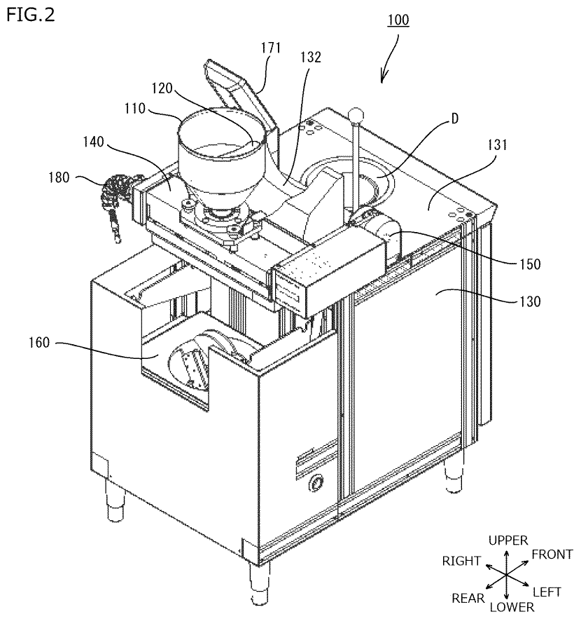

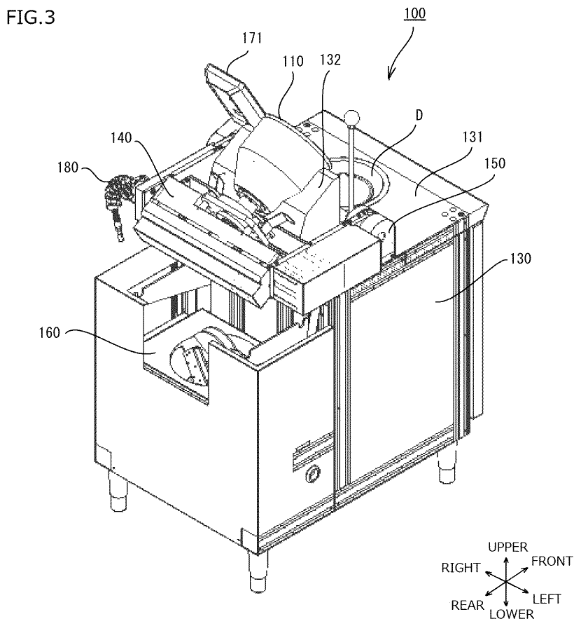

FIG. 1 is a right perspective view of the automatic cooking apparatus 100 according to the first embodiment of the present invention, and FIG. 2 is a rear left perspective view of the automatic cooking apparatus 100 illustrated in FIG. 1. FIG. 1 and FIG. 2 both illustrate the cooking container 110 in a posture for receiving ingredients. However, the posture for receiving ingredients illustrated in FIGS. 1 and 2 is an example of a posture in which the cooking container easily receives ingredients. The present embodiment is not limited to the case where the cooking container 110 takes this posture at the time of supplying the ingredients, and it is possible to supply the ingredients to the cooking container 110 even when the cooking container 110 is in the cooking posture, for example, as illustrated in FIG. 3, which will be described later.

The automatic cooking apparatus 100 includes the cooking container 110 which is detachable, a cooking cabinet 130, a container holding unit 140, a dishing-up unit 150, a washing unit 160, and a control unit 170 (not illustrated). The automatic cooking apparatus 100 operates with power supplied through a power supply cord 180. The cooking cabinet is provided with an upper surface 131 and a container heating unit 132, and a plate as a dishing-up container D is placed on the upper surface 131. Furthermore, an operation panel 171 for inputting cooking operations to the automatic cooking apparatus 100 and displaying operational states of the automatic cooking apparatus 100 is provided above the dishing-up unit 150. The cooking container 110 is a bottomed cylindrical container, and an agitation member 120 is provided inside the cooking container 110.

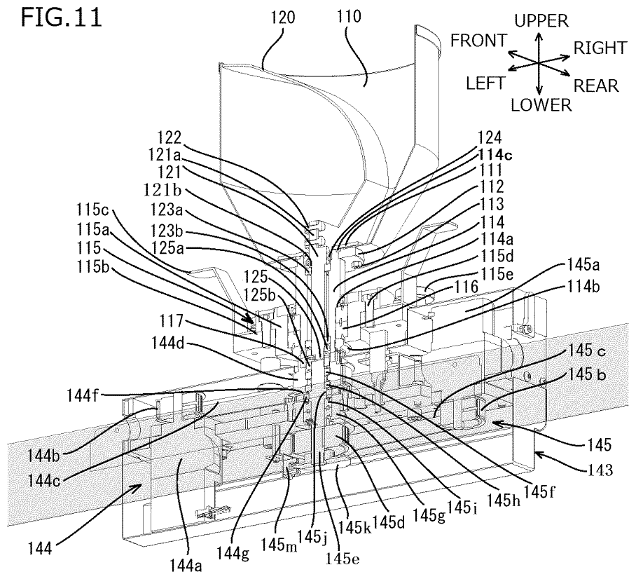

The container holding unit 140 includes a container rotation mechanism 144 (see FIG. 11) configured to hold the cooking container 110 and cause the cooking container 110 to rotate around a container rotation shaft 114 (see FIG. 11). The agitation member 120 is provided inside the cooking container 110. The container holding unit 140 is provided with an agitation member drive mechanism 145 (see FIG. 11) configured to rotationally drive the agitation member 120. The rotational driving of the agitation member 120 by the agitation member drive mechanism 145 can be set to be separate from the rotation of the cooking container 110 by the container rotation mechanism 144. Thus, when the cooking container 110 is in a first motional state defined by a rotational direction, a rotational speed, or a stationary motional state thereof, the agitation member 120 can assume a second motional state that is different from the first motional state of the cooking container 110. In addition, the agitation member drive mechanism 145 can set the motional state of the agitation member 120 to the second motional state different from the first motional state of the cooking container set by the container rotation mechanism 144. For example, when the operational state of the cooking container 110 is the right rotation, the left rotation, or the stationary state, the agitation member drive mechanism 145 can set the operational state of the agitation member 120 to any of the right rotation, the left rotation, or the stationary state.

Furthermore, the container holding unit 140 is configured to be pivotally driven with respect to the dishing-up unit 150. Therefore, the container holding unit 140 can change the posture of the cooking container 110 in the front-rear direction and the up-down direction. By tilting the cooking container 110 from the position of FIG. 1 to the front side, the container holding unit 140 can change the posture of the cooking container 110 to a cooking posture located in the container heating unit 132. Furthermore, by tilting the cooking container 110 from the position of FIG. 1 to the rear side to change the posture thereof so that the opening of the cooking container faces downward, the container holding unit 140 can change the posture of the cooking container 110 to the washing posture positioned in the washing unit 160.

The dishing-up unit 150 is configured to be rotationally driven by a dishing-up posture actuator 152 (not illustrated). Therefore, when the cooking container 110 is in the cooking posture located in the container heating unit 132, the dishing-up unit 150 is rotationally driven together with the container holding unit 140, so that the posture of the cooking container 110 can be changed to the dishing-up posture in which the opening faces downward.

FIG. 3 is a rear left perspective view of the automatic cooking apparatus 100 illustrated in FIG. 1 in the cooking posture. By tilting the cooking container 110 to the front side from the ingredient receiving posture in FIG. 1, the container holding unit 140 can change the posture of the cooking container 110 to the cooking posture located in the container heating unit 132. The container heating unit 132 is provided with, for example, an IH heater 132a as a heating device, and the temperature of the heating device is controlled to a heating temperature corresponding to a cooking menu input from the operation panel 171. Here, although the IH heater 132a is exemplified as the heating device of the container heating unit 132, the present embodiment is not limited thereto. Any type of heating device can be adopted, such as a heater that uses an electric heating wire, a combustion-type heating device, or the like, as long as the heating temperature can be controlled.

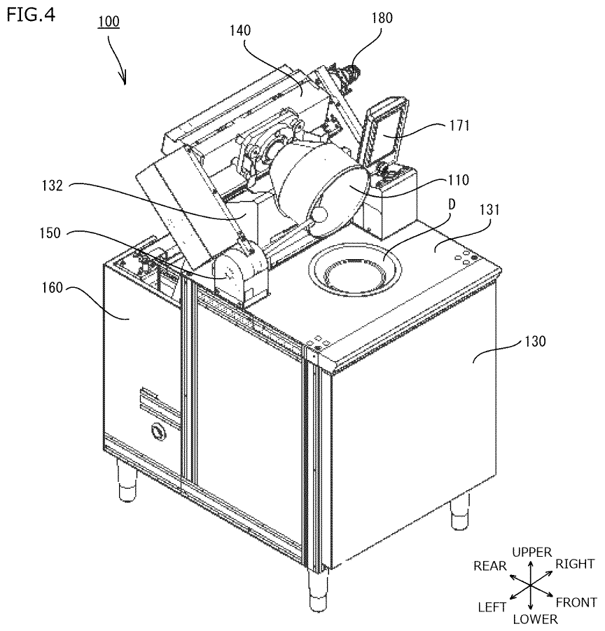

FIG. 4 is a left perspective view of the automatic cooking apparatus 100 illustrated in FIG. 1 in the dishing-up posture. From the cooking posture of FIG. 3, by rotationally driving the dishing-up unit 150 in the forward direction together with the container holding unit 140 by the dishing-up posture actuator 152, the posture of the cooking container 110 can be changed to the dishing-up posture in which the opening of the cooking container 110 faces downward. At this time, the container heating unit 132 remains fixed to the cooking cabinet 130 and does not move together with the dishing-up unit 150. Since the container heating unit 132 remains fixed in the dishing-up posture, it offers advantages such as eliminating the need to drive the heavy part including the heating device, simplifying the routing of the wiring of the heating device, and making thermal insulation measures for the heating device easier to implement. Various actuators such as a rotary motor, an electric linear actuator, and a hydraulic or pneumatic actuator may be employed as the dishing-up posture actuator 152. Furthermore, although the present embodiment has been described as using the dishing-up posture actuator 152 to rotationally drive the dishing-up unit 150, the present embodiment is not limited to this configuration. For example, a rotary drive device such as a manual lever 151 or the like may be provided in place of the dishing-up posture actuator 152, or in combination therewith. When the dishing-up posture actuator 152 is provided, a manual lever 151 can be omitted.

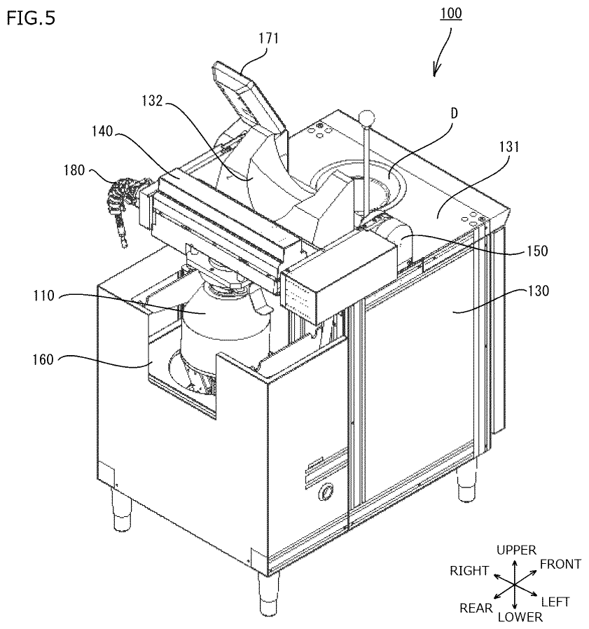

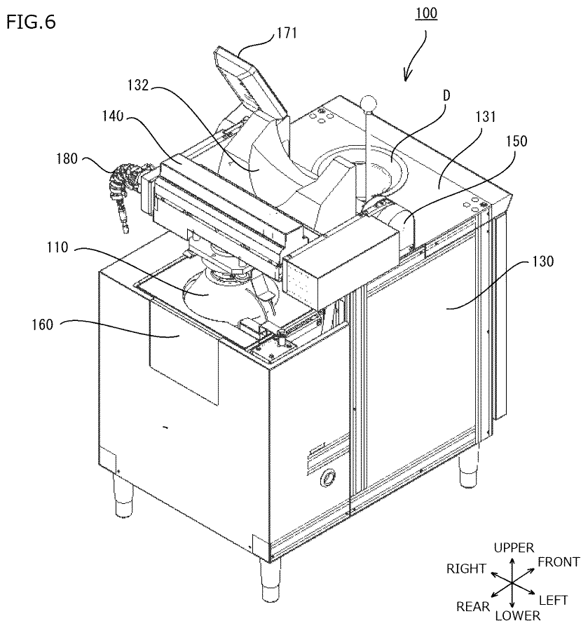

FIG. 5 is a rear left perspective view of the automatic cooking apparatus 100 illustrated in FIG. 1 in a washing posture, and FIG. 6 is a rear left perspective view of the automatic cooking apparatus 100 illustrated in FIG. 1 during washing. First, from the dishing-up posture of FIG. 4, the posture of the dishing-up unit 150 is returned to the dishing-up posture of FIG. 3, together with the container holding unit 140, by the dishing-up posture actuator 152. Next, from the dishing-up posture of FIG. 3, the cooking container 110 is changed in posture to be tilted backward, positioning its opening to face downward. As a result, the container holding unit 140 can move the cooking container 110 into a washing posture and position it at the washing unit 160. At this time, the washing unit 160 is moved to a retracted position below the cooking cabinet 130 so as not to interfere with the cooking container 110. When the posture of the cooking container 110 is changed to the washing posture, the washing unit 160 is controlled to move from the retracted position illustrated in FIG. 5 to the washing position illustrated in FIG. 6.

By the operations illustrated in FIG. 1 to FIG. 6, the automatic cooking apparatus 100 of the present embodiment can change the posture of the cooking container 110 to the postures including:
(1) an ingredient receiving posture for having the cooking container receive the ingredient;
(2) a cooking posture for having the cooking container be rotated by the container rotation mechanism to cook the ingredient;
(3) a dishing-up posture in which the cooking container is caused to face downward to a dishing-up container; and
(4) a washing posture for washing the cooking container with an opening side of the cooking container facing downward.

This makes it possible to appropriately automate all the steps of receiving the ingredients, cooking, dishing-up, and washing.

Next, a procedure for automatic cooking by the automatic cooking apparatus 100 will be described. First, the contents of cooking to be performed by the automatic cooking apparatus 100 are input from the operation panel 171. The input of the cooking content is achieved by selecting, for example, a cooking menu, an amount of food, a heating time, a recipe, and the like. Since the operation panel 171 has a preset function, a plurality of menus and cooking methods can be stored in advance. In addition, the heating time and the agitation cooking can be set by an interactive input. In addition to setting of the preset menus, it is also possible to directly configure the heating time, the speed setting of the cooking container and the agitation member, the washing time, and other parameters.

When the cooking content is input from the operation panel 171, the cooking container 110 is controlled to be in the ingredient receiving posture (FIG. 1 and FIG. 2), so that the cooking container 110 receives ingredients. Next, the cooking container 110 is controlled to be in the cooking posture (FIG. 3), and the ingredients are cooked for a heating time under a certain agitating condition according to the cooking content input from the operation panel 171. Note that even if the cooking content involves agitating, heating is not necessarily required. For example, it is also possible to cook salads, chirashi sushi (vinegared rice with pieces of raw fish, vegetables and the like on top), Maze Gohan (mixed rice), and the like, which do not require heating.

Next, the cooking container 110 is controlled to be in the dishing-up posture (FIG. 4), and the cooking container 110 and/or the agitation member 120 are/is rotationally driven while being in the dishing-up posture, to perform the dishing-up automatically. Here, although the dishing-up has been described as being performed automatically, the present embodiment is not limited to this configuration. The dishing-up may also be performed manually or as a combination of automatic and manual methods, as necessary.

After the dishing-up, the cooking container 110 is controlled to be in the washing posture (FIG. 5 and FIG. 6), and the cooking container 110 is washed using a water flow by the washing unit. After the washing is completed, the cooking content is input again from the operation panel 171. Alternatively, when the cooking content that is continuous from the previous one has already been input, the input from the operation panel 171 is skipped, and the next cooking operation is performed.

### 2. Shape of Agitation Member 120

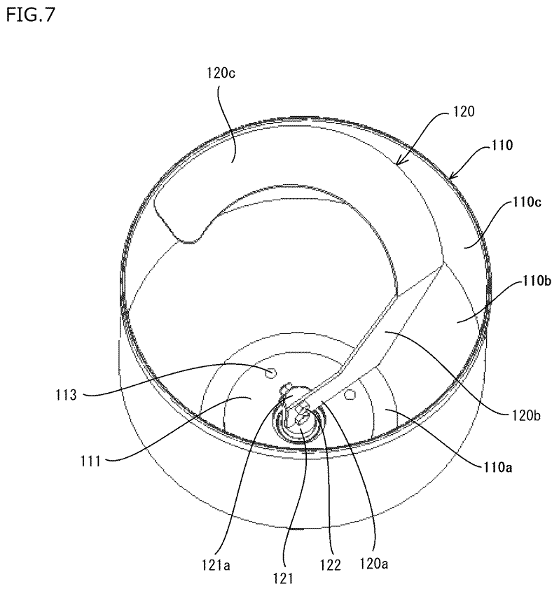

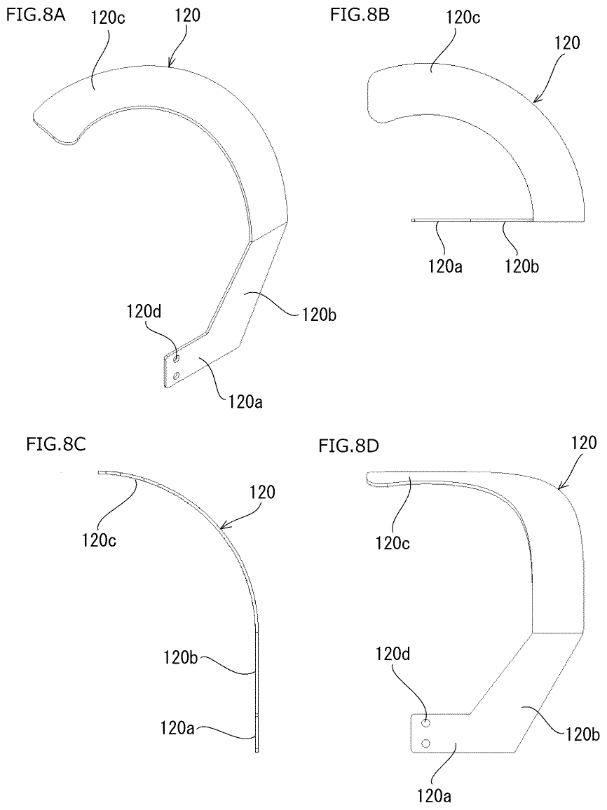

FIG. 7 is a perspective view of the cooking container 110 of the automatic cooking apparatus 100 illustrated in FIG. 1, and FIG. 8A to FIG. 8D include elevation views of the agitation member 120 of the automatic cooking apparatus 100 illustrated in FIG. 1. FIG. 8A is a perspective view, FIG. 8B is a top view, FIG. 8C is a left side view, and FIG. 8D is a front view.

The agitation member 120 is composed of a base portion 120a, a straight portion 120b, and a curved portion 120c. On the other hand, the cooking container 110 is composed of a bottom surface portion 110a, an inclined surface portion 110b, and a side surface portion 110c. The shape of the agitation member is formed such that the base portion 120a is along the bottom surface portion 110a, the straight portion 120b is along the inclined surface portion 110b, and the curved portion 120c is along the side surface portion 110c. Furthermore, the base portion 120a and the straight portion 120b are flush with each other, and the curved portion 120c is curved as viewed in the top view and the front view.

### 3. Container Holding Unit 140

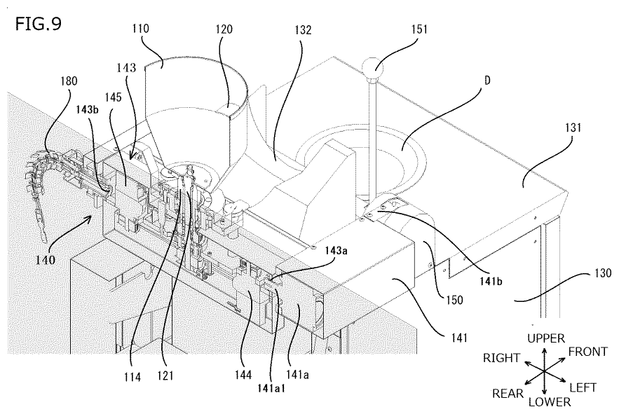

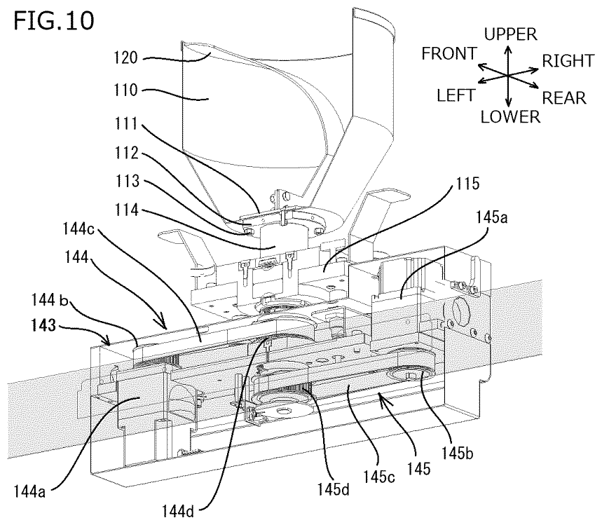

Next, the structure of the container holding unit 140 will be described with reference to FIGS. 9 to 11. FIG. 9 is a rear-side cross-sectional view of the automatic cooking apparatus 100 illustrated in FIG. 1, FIG. 10 is a rear-side partial cross-sectional view of the automatic cooking apparatus 100 illustrated in FIG. 1, and FIG. 11 is a rear-side partial cross-sectional view of the automatic cooking apparatus 100 illustrated in FIG. 1.

The container holding unit 140 includes a posture control mechanism 141 and a container drive subunit 143. The posture control mechanism 141 includes a posture control motor 141a and a rotary drive arm 141b. The dishing-up unit 150 includes the dishing-up actuator 152 (not illustrated). The rotary drive arm 141b is rotationally driven about a rotation shaft of the rotary drive arm 141 by the dishing-up actuator 152. As the dishing-up actuator 152, for example, a linear actuator, a rotary motor, or the like can be used. For example, a linear actuator is mounted between the rotary drive arm 141b and the cooking cabinet 130. Furthermore, for example, the rotary motor rotationally drives the rotary drive arm 141b around the rotation shaft by direct driving, gear driving, belt driving, or the like. The container drive subunit 143 includes the container rotation mechanism 144 and the agitation member drive mechanism 145. The posture of the cooking container 110 is controlled by the container holding unit 140 and the dishing-up unit 150.

### 3.1. Posture Control Mechanism 141

The posture control mechanism 141 includes the rotary drive arm 141b and the posture control motor 141a attached to the rotary drive arm 141b. The posture control motor 141a can control the angle of the cooking container 110 in the front-rear direction and the up-down direction by rotationally driving the container drive subunit 143. Shaft insertion holes 143a and 143b are provided at left and right ends of the container drive subunit 143, respectively. A drive shaft 141a1 of the posture control motor 141a is fixed to the left shaft insertion hole 143a. A shaft (not illustrated) protruding from the right rotary drive arm 141b is inserted into the right shaft insertion hole 143b. The container drive subunit 143 is subjected to posture control in the front-rear direction and the up-down direction by the posture control motor 141a around the axis line in the left-right direction of both the shaft insertion holes 143a and 143b with the aid of the pair of left and right shaft insertion holes 143a and 143b. As described above, the rotary drive arm 141b is rotationally driven about the rotation shaft of the rotary drive arm 141b by the dishing-up actuator 152. Consequently, the posture of the cooking container 110 is controlled to be the ingredient receiving posture, the cooking posture, the dishing-up posture, and the washing posture.

### 3.2. Container Rotation Mechanism 144

The agitation member rotation shaft 121 is arranged concentrically inside the hollow container rotation shaft 114. The agitation member rotation shaft 121 and the hollow container rotation shaft 114 are axially supported by the container drive subunit 143 so that they can rotate relative to each other and independently. The container rotation mechanism 144 is configured to drive a container-side passive pulley 144d connected to the hollow container rotation shaft 114 by action of the driving force of a container drive motor 144a via a container drive belt 144c. A container drive pulley 144b configured to drive the container drive belt 144c is attached to the output shaft of the container drive motor 144a. Since the container drive pulley 144b is connected to the container rotation shaft 114, the container drive motor 144a can control the rotational motion of the cooking container via the container drive belt 144c. The container drive motor 144a is not particularly limited, and for example, a brushless motor can be adopted. The container drive belt 144c is not particularly limited, and for example, a rubber or polyurethane belt can be adopted.

### 3.3. Agitation Member Drive Mechanism 145

The agitation member drive mechanism 145 is configured to drive an agitation member-side driven pulley 145d by the driving force of the agitation member drive motor 145a via an agitation member drive belt 145c. Here, the agitation member-side driven pulley 145d is axially supported concentrically inside the hollow container rotation shaft 114 and is fixed to an agitation member drive shaft 145e that is connected to the agitation member rotation shaft 121. An agitation member drive pulley 145b configured to drive the agitation member drive belt 145c is attached to an output shaft of the agitation member drive motor 145a. Furthermore, the agitation member drive mechanism 145 includes an encoder 145m configured to detect a rotational angle of the agitation member drive shaft 145e. The encoder 145m can detect the rotational speed and the rotational position of the agitation member 120 by detecting the rotation information of a rotating plate 145k fixed below the agitation member-side driven pulley 145d of the agitation member drive shaft 145e. Since the agitation member drive pulley 145b is connected to the agitation member rotation shaft 121, the agitation member drive motor 145a can control the rotational speed and the rotational position of the agitation member 120 via the agitation member drive belt 145c. The agitation member drive motor 145a is not particularly limited, and for example, a stepping motor or the like can be adopted so as to facilitate positioning control. The agitation member drive belt 145c is not particularly limited, and for example, a rubber or polyurethane belt can be adopted.

### 3.4. Container Rotation Shaft 114 and Agitation Member Rotation Shaft 121

As described above, the agitation member rotation shaft 121 is arranged concentrically inside the hollow container rotation shaft 114. The agitation member rotation shaft 121 and the hollow container rotation shaft 114 are axially supported by the container drive subunit 143 so that they can rotate relative to each other and independently. Next, the structure of the container rotation shaft 114 and the agitation member rotation shaft 121 will be described in detail.

The cooking container 110 is fixed to an upper end of the container rotation shaft 114. At the center of the bottom surface portion 110a of the cooking container 110, a bottom surface through hole is provided to fix the cooking container 110 to the container rotation shaft 114. Inside the bottom surface through hole, a container inner fixing plate 111 overlaps an upper part of a container outer fixing plate 112, and at the same time, the bottom surface portion 110a of the cooking container 110 is interposed between the container outer fixing plate 112 and the container inner fixing plate 111 and fixed by container fixing screws 113. Here, an O-ring 114c is provided between the container rotation shaft 114, the container outer fixing plate 112, and the container inner fixing plate 111.

The container rotation shaft 114 is, in a rotatable manner, axially supported at its lower portion by a container attachment mechanism 115. The container attachment mechanism 115 includes a base portion 115b, a grip portion 115c fixed to the base portion 115b, and a bearing support portion 115a fixed to the inside of the base portion 115b by a screw 115d. A container bearing 116 is provided inside the bearing support portion 115a. A thrust receiving portion 114a of the container rotation shaft 114 is in sliding contact with an inner upper portion of the container bearing 116, thereby constituting a thrust bearing against a downward force. A thrust receiving ring 114b is provided below the container bearing 116 on the outer side of the container rotation shaft 114. The thrust receiving ring 114b is in sliding contact with the inner lower portion of the container bearing 116, thereby constituting a thrust bearing against an upward force.

Inside the container rotation shaft 114, the agitation member rotation shaft 121 is, in a rotatable manner, axially supported by agitation member bearings 123a and 123b. The base portion 120a of the agitation member 120 is fixed to an agitation member attachment portion 121a at the upper end of the agitation member rotation shaft 121 by agitation member fixing screws 122. On the inner upper side of the upper agitation member bearing 123a, the thrust receiving portion 121b of the agitation member rotation shaft 121 is in sliding contact therewith, thereby constituting a thrust bearing against a downward force. An oil seal 124 is provided inside the container rotation shaft 114 above the thrust receiving portion 121b to prevent liquid leakage to the inside of the container rotation shaft 114. An agitation member rotation shaft coupling portion 125, which is configured to connect the agitation member rotation shaft 121 and the agitation member drive shaft 145e in a positive-fit manner, is positioned below the lower agitation member bearing 123b. Consequently, the lower surface of the lower agitation member bearing 123b and the upper surface 125a of the agitation member rotation shaft coupling portion 125 constitute a thrust bearing against an upward force.

The container-side passive pulley 144d is connected to the lower end of the container rotation shaft 114 in a positive-fit manner, thereby constituting a container fixing shaft coupling portion 117. A bearing support portion 145g that supports the agitation drive bearing 145i is fixed to the container drive subunit 143 by screws. A thrust bearing 144g is provided at a lower end of the container-side passive pulley 144d. A thrust receiving portion 144f of the container-side passive pulley 144d is in sliding contact with the thrust bearing 144g.

The container attachment mechanism 115 integrally rotatably supports the cooking container 110 and the agitation member 120, and allows the cooking container 110 to be attached to and detached from the automatic cooking apparatus 100 by attaching and detaching the container attachment mechanism 115 to and from the container drive subunit 143 while the cooking container 110, the agitation member 120, and the container attachment mechanism 115 are integrated as an integral unit. Attachment and detachment of the container rotation shaft 114 and the container-side passive pulley 144d and attachment and detachment of the agitation member rotation shaft 121 and the agitation member drive shaft 145e are realized by positive-fit. That is, for example, by providing irregularities that mesh with each other between the shafts, they can be connected to each other so as to be able to transmit the rotational force to each other by mutually meshing. When the container attachment mechanism 115 is attached to the container drive subunit 143, it is fixed by an attachment screw 115e.

Bearings 145f and 145h are provided on an inner periphery of the container-side passive pulley 144d. The agitation member drive shaft 145e is axially supported on the inner side of the bearings 145f and 145h. A lower surface 125b of the agitation member rotation shaft coupling portion 125 is in sliding contact with the upper surface of the bearing 145f. Furthermore, the diameter of the agitation member drive shaft 145e is increased to provide a thrust receiving portion 145j having an increased diameter above an agitating drive bearing 145i. The upper and lower portions of the thrust receiving portion 145j are in sliding contact with the bearing 145h and the agitating drive bearing 145i, respectively. A rotating plate 145k is attached to a lower end portion of the agitation member drive shaft 145e, and an encoder 145m is provided to face the rotating plate 145k.

With such a structure, the agitation member 120 can assume the second motional state that is different from the first motional state of the cooking container 110 when the cooking container 110 is in the first motional state defined by the rotational direction, rotational speed, or a stationary motional state thereof. In addition, the agitation member drive mechanism 145 can set the motional state of the agitation member 120 to the second motional state different from the first motional state of the cooking container 110 by the container rotation mechanism 144. For example, when the operational state of the cooking container 110 is the right rotation, the left rotation, or the stationary state, the agitation member drive mechanism 145 can set the operational state of the agitation member 120 to any of the right rotation, the left rotation, or the stationary state. As described above, the agitation member drive mechanism 145 can control the agitation member 120 independently of the rotational motion of the cooking container 110 by the container rotation mechanism 144. Moreover, the agitation member drive mechanism 145 can grasp the rotational position and/or speed of the agitation member 120 and appropriately control the rotational position and/or speed of the agitation member 120 in accordance with the cooking content input from the operation panel 171.

In addition, the cooking container 110 may assume a posture in which the opening of the cooking container 110 faces downward, such as a washing posture or a dishing-up posture, as well as a posture in which the opening thereof faces upward. According to the structure of the container rotation shaft 114 and the agitation member rotation shaft 121 as described above, it is possible to axially support the cooking container 110 appropriately by supporting the thrust load and the radial load due to the cooking container 110 by the bearing mechanism, regardless of the posture of the cooking container 110.

### 4. Washing Unit 160

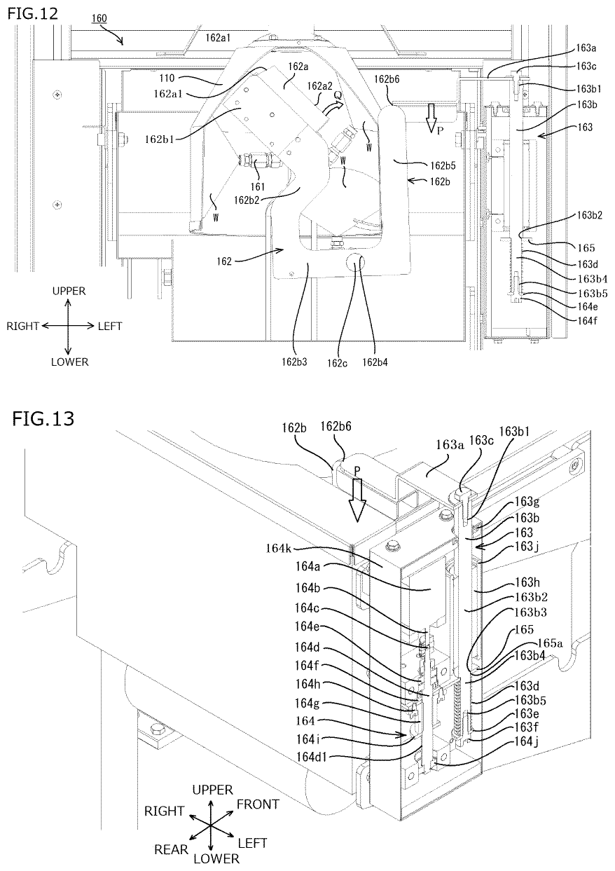

Next, the structure of the washing unit 160 will be described with reference to FIGS. 12 and 13. FIG. 12 is a cross-sectional view of the washing unit 160 of the automatic cooking apparatus 100 illustrated in FIG. 1, and FIG. 13 is a left-side cross-sectional view of the washing unit 160 of the automatic cooking apparatus 100 illustrated in FIG. 1.

The washing unit 160 includes a plurality of nozzles 161 for washing the cooking container 110 with water flow. The inner surface of the cooking container 110 can be washed by the water flow ejected from the plurality of nozzles. The water flow from the plurality of nozzles is controlled by a solenoid valve 166 (not illustrated). While the solenoid valve 166 controls on/off of the water flow ejected from each nozzle, the solenoid valve 166 may further control the amount of water and the water pressure of the water flow ejected from each nozzle. A water tank is provided in the washing unit 160, and the water in the water tank is heated by a heater to be hot water, and the hot water is ejected from the nozzle, whereby the washing water can be circulated to wash the cooking container. Depending on the degree of soiling, it is also possible to use a washing agent. It is preferable to use tap water instead of circulating water for rinsing. A rinsing agent can also be used to facilitate drying.

The washing unit 160 is provided with a scraper pushing mechanism 162, a pressing mechanism 163, and a drive mechanism 164, so that a scraper 162a can be pushed against the cooking container 110 during washing. The residues inside the cooking container 110 can be scraped off by causing the cooking container 110 to rotate while the scraper 162a is brought into elastic contact with the cooking container 110. A configuration in which the scraper 162a is pushed against the cooking container 110 will be described in detail.

### 4.1. Scraper Pushing Mechanism 162

The scraper pushing mechanism 162 includes the scraper 162a and a scraper pushing member 162b. The scraper 162a is a substantially rectangular member having a bottom edge 162a1 and a side edge 162a2. The shapes of the bottom edge 162a1 and the side edge 162a2 correspond to the shape of the bottom surface portion 110a and that of the inclined surface portion 110b of the cooking container 110, respectively. Therefore, when the scraper 162a is pushed against the inside of the cooking container 110, the bottom edge 162a1 and the side edge 162a2 are adapted to the bottom surface portion 110a and the inclined surface portion 110b of the cooking container 110, respectively, so that the respective residues can be scraped off.

The scraper pushing member 162b includes a scraper fixing portion 162b1, a curved portion 162b2, a pivot support portion 162b3, and an operating portion 162b5. The scraper 162a is fixed to the scraper fixing portion 162b1 in such a posture where the bottom edge 162a1 and the side edge 162a2 are pushed against the bottom surface portion 110a and the inclined surface portion 110b of the cooking container 110, respectively.

The pivot support portion 162b3 is provided with a pivot hole 162b4, and a pivot shaft 162c is inserted into the pivot hole, so that the scraper pushing member 162b can swing around the pivot shaft 162c. An operation point 162b6 for receiving a pressing force in a P direction from a pressing member 163a, which will be described later, is provided at a distal end of the operating portion 162b5. When a pressing force in the P direction is applied to the operation point 162b6, the scraper pushing member 162b swings in a Q direction about the pivot shaft 162c, and the scraper 162a is pushed against the inner surface of the cooking container 110.

The shape of the scraper pushing member 162b is substantially U-shaped, and the shape and the position of the pivot hole are balanced such that the scraper 162a is directed away from the inner surface of the cooking container 110 by the weight of the scraper pushing member 162b itself. Therefore, when the pressing force in the P direction that has been applied to the operation point 162b6 is released, the scraper pushing member 162b swings in a direction in which the operation point 162b6 pushes the pressing member 163a back, that is, in a direction opposite to the P direction and the Q direction, due to its own weight.

### 4.2. Pressing Mechanism 163

The pressing mechanism 163 transmits the driving force from the drive mechanism 164 to the operation point 162b6 of the operation portion 162b5 of the scraper pushing mechanism 162 via a buffer member 163b and the pressing member 163a.

The pressing mechanism 163 includes the pressing member 163a, the buffer member 163b, a screw 163c, a spring member 163d, a spring receiving member 163e, a screw 163f, an oil seal 163g, and a sliding member 163h. The buffer member 163b is a rod-shaped member, and has a screw hole 163b1, a sliding contact portion 163b2, a stepped portion 163b3, a small diameter portion 163b4, and a screw hole 163b5, which are provided in this order from above. The pressing member 163a is fixed to the screw hole 163b1 by the screw 163c. The hollow cylindrical sliding member 163h is fixed to a housing 164k. The sliding contact portion 163b2 is in sliding contact with the inside of the sliding member 163h, so that the sliding contact portion 163b2 slides in the up-down direction. The small diameter portion 163b4 is provided below the sliding contact portion 163b2, and the stepped portion 163b3 is provided between the sliding contact portion 163b2 and the small diameter portion 163b4. The small diameter portion 163b4 is inserted into a through hole 165a of the drive plate 165, and has a positional relation in which the upper end of the drive plate 165 can abut against the stepped portion 163b3.

The spring receiving member 163e is fixed to the screw hole 163b5 at the lower end of the small diameter portion 163b4 by the screw 163f. The spring member 163d that is cylindrical is concentrically provided on an outer periphery of the small diameter portion. While the spring member 163d is compressed, the lower end thereof is in contact with the spring receiving member 163e, and the upper end thereof is in elastic contact with the drive plate 165. As a result, the driving force of the drive plate 165 is transmitted to the buffer member 163b while the drive plate 165 is in elastic contact with the stepped portion 163b3 with the pressing force of the spring member 163d.

The drive plate 165 is driven in the up-down direction by the drive mechanism 164, which will be described later. Since the drive plate 165 is pushed against the stepped portion 163b3 by the elastic force of the spring member 163d, the buffer member 163b also slides in the up-down direction in conjunction with the up-down movement of the drive plate 165. As a result, the driving force of the drive mechanism 164 is transmitted to the pressing member 163a via the drive plate 165 and the buffer member 163b.

During an operation in which the cooking container 110 is rotationally driven while the scraper 162a is pushed against the inner surface of the cooking container 110 so that residues adhering to the inner surface of the cooking container 110 are scraped off by the scraper 162a, a reaction force against the force in the Q direction that pushes the scraper 162a against the inner surface of the cooking container 110 may be generated. This reaction force is applied to the buffer member 163b as a force (upward force) in a direction opposite to the P direction from the operation point 162b6 to the pressing member 163a. Here, when the reaction force is large, the drive plate 165 moves downward away from the stepped portion 163b3 against the elastic force of the spring member 163d. Accordingly, since the buffer member 163b has a buffer function, the scraper 162a can be brought into elastic contact with the inner surface of the cooking container 110.

### 4.3. Drive Mechanism 164

The drive mechanism 164 drives the drive plate 165, so that the driving force thereof is transmitted to the scraper pushing mechanism 162 via the above-described pressing mechanism 163.

The drive mechanism 164 includes a scraper drive motor 164a. Rotation of the scraper drive motor 164a is transmitted to a drive member 164d via a motor drive shaft 164b and a shaft connecting portion 164c. The drive member 164d is a rod-shaped member and includes a screw-threaded portion 164d1. The drive member 164d is axially supported by an upper bearing 164e and a lower bearing 164j. A female screw member 164g is engaged with the screw-threaded portion 164d1. An upper end of the female screw member 164g is fixed to the drive plate 165 by a fixing screw 164h. Since the drive plate 165 is shaped to correspond to the inner surface of the housing 164k, the female screw member 164g does not rotate. As a result, the female screw member 164g is driven in the up-down direction in accordance with the rotation of the scraper drive motor 164a, and this driving force is transmitted to the pressing mechanism 163 via the drive plate 165. The extent to which the female screw member 164g is driven is limited by an upper stopper 164f provided above the drive plate 165 and a lower stopper 164i provided below the female screw member 164g.

As described above, the washing unit 160 is provided with the scraper pushing mechanism 162, the pressing mechanism 163, and the drive mechanism 164, so that the scraper 162a can be pushed against the cooking container 110 during washing. When the cooking container 110 is caused to rotate while the scraper 162a is pushed during washing, residues on the inner surface of the cooking container 110 can be scraped off by the scraper 162a at the same time as the washing with the water flow. Although burnt residues may be generated on the inner surface of the cooking container 110 after the stir-frying with strong thermal power, the scraper 162a scrapes off the residues from the inner surface of the cooking container 110, so that washing of the cooking container 110 can be more effectively achieved even when burnt residues occurs. If the pressing force is too strong when the scraper 162a is pushed against the inner surface of the cooking container 110, problems such as overloading the container rotation mechanism 144 and damaging the inner surface of the cooking container 110 may occur. Therefore, the use of the buffer member 163b in the pressing mechanism 163 allows the scraper 162a to be brought into elastic contact with the inner surface of the cooking container 110, ensuring that the scraper 162a is constantly pushed against the inner surface of the cooking container 110 with an appropriate pressing force. Consequently, this configuration enhances the washing efficiency and helps prevent failures.

### 5. Control Unit 170

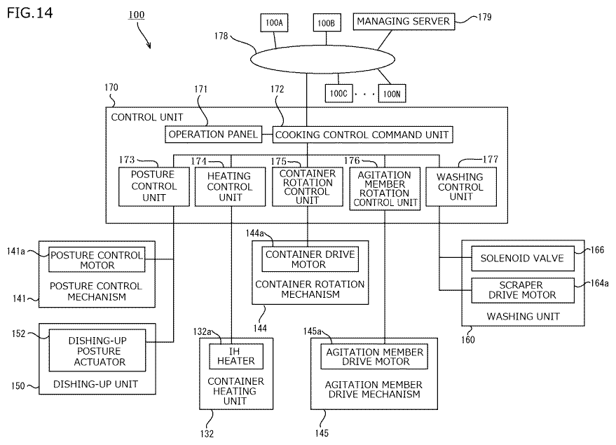

Next, the control unit 170 will be described with reference to FIG. 14. FIG. 14 is a system configuration diagram of the automatic cooking apparatus 100 illustrated in FIG. 1.

The control unit 170 of the automatic cooking apparatus 100 includes the operation panel 171, a cooking control command unit 172, a posture control unit 173, a heating control unit 174, a container rotation control unit 175, an agitation member rotation control unit 176, and a washing control unit 177. The cooking control command unit 172 is connected to the respective control units 173 to 177 and the operation panel 171 in order to control the automatic cooking apparatus 100 to execute cooking according to the cooking content input from the operation panel 171.

Furthermore, the cooking control command unit 172 is connected to other automatic cooking apparatuses 100A to 100N and a managing server 179 via an external network. The managing server 179 may be, for example, a cloud server. In the automatic cooking apparatus 100, the managing server 179 manages cooking menu information, cooking control information, maintenance information, and the like.

The cooking content input from the operation panel 171 is transmitted to the cooking control command unit 172. Furthermore, cooking status information and the like are transmitted from the cooking control command unit 172 to the operation panel 171, and so the information can be displayed on the operation panel 171. The posture control unit 173 controls the drive motor 141a of the posture control mechanism 141 and the dishing-up posture actuator 152 of the dishing-up unit 150 to control the posture of the cooking container 110. The heating control unit 174 controls the IH heater 132a of the container heating unit 132 to control the heating condition such as the heating temperature and the heating time of the cooking container 110. The container rotation control unit 175 controls the container drive motor 144a of the container rotation mechanism 144 to control the rotational direction and the rotational speed of the cooking container 110. The agitation member rotation control unit 176 controls the agitation member drive motor 145a of the agitation member drive mechanism 145 to control the rotational position, rotational direction, rotational speed, and the like of the agitation member 120.

The agitation member rotation control unit 176 can control the position and the speed of the agitation member 120 according to the position and speed information of the agitation member 120. For example, when the cooking container 110 is in the cooking posture, the agitation member rotation control unit 176 can control the rotational direction and rotational speed of the agitation member 120 to control the agitating state of the ingredients. In addition, for example, when the cooking container 110 is in the washing posture, the agitation member rotation control unit 176 can control the agitation member 120 to be positioned at a rotational angle at which the agitation member 120 does not interfere with the scraper 162a of the washing unit 160. Furthermore, for example, when the cooking container 110 is in the dishing-up posture, the agitation member rotation control unit 176 can control the rotational position, rotational direction, and rotational speed of the agitation member 120 to control the dishing-up state.

The washing control unit 177 controls the solenoid valve 166 and the scraper drive motor 164a of the washing unit 160. The washing control unit 177 controls the solenoid valve 166 to control on/off, water amount, water pressure, and the like of the water flow ejected from each nozzle 161. Furthermore, the washing control unit 177 can control the scraper drive motor 164a to push the scraper 162a against the inner surface of the cooking container 110 to scrape off residues from the inner surface of the cooking container 110.

The respective control units 173 to 177 of the control unit 170 can perform control in cooperation with each other in accordance with a cooking command from the cooking control command unit 172. For example, when the cooking container 110 is in the cooking posture, the heating control unit 174, the container rotation control unit 175, and the agitation member rotation control unit 176 are controlled in cooperation with each other so that the heating state and the agitating state of the ingredients are in an appropriate state corresponding to the cooking content input from the operation panel 171. Furthermore, for example, when the cooking container 110 is in the washing posture, the container rotation control unit 175, the agitation member rotation control unit 176, and the washing control unit 177 are controlled in cooperation with each other so as to control the pushing of the scraper 162a, the rotation of the cooking container 110, the water flow, and the like while the agitation member 120 is controlled to be positioned at a rotation angle at which the agitation member 120 does not interfere with the scraper 162a. In addition, for example, when the cooking container 110 is in the dishing-up posture, the container rotation control unit 175 and the agitation member rotation control unit 176 are controlled in cooperation with each other so that the food cooked in the cooking container 110 by the agitation member 120 is appropriately dished up in the dishing-up container D. Furthermore, for example, since the posture control of the cooking container 110 needs to be synchronized with the control by the respective control units 174 to 177, the posture control unit 173 is controlled in cooperation with the respective control units 174 to 177.

### 6. Cooking Example

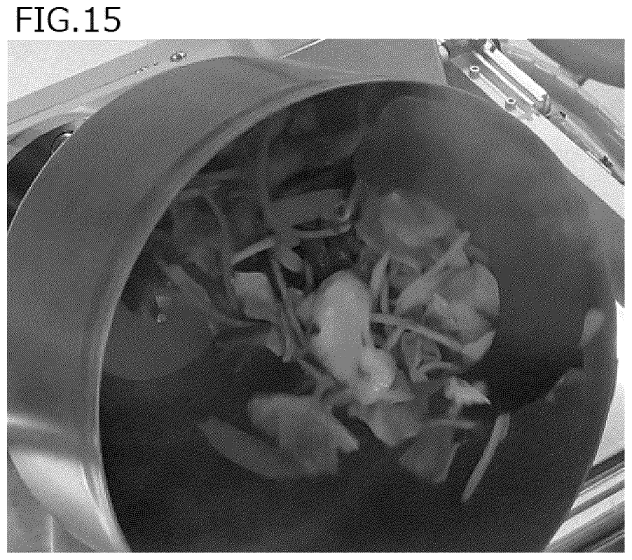

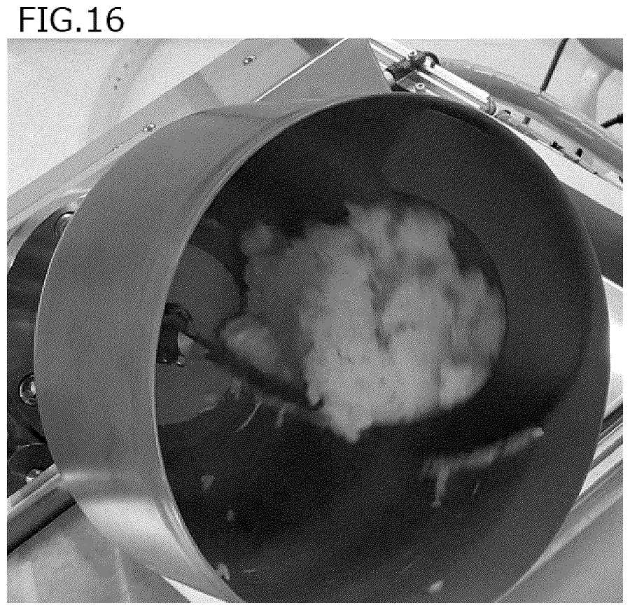

Next, with reference to FIGS. 15 and 16, a cooking example by the automatic cooking apparatus 100 of the present embodiment will be described. FIG. 15 shows a first cooking example of the automatic cooking apparatus 100 illustrated in FIG. 1, and FIG. 16 shows a second cooking example of the automatic cooking apparatus 100 illustrated in FIG. 1.

The first cooking example shown in FIG. 15 is an example of cooking stir-fried vegetables. In order to cook with strong thermal power, the cooking container 110 needs to be rotated while the ingredients are agitated and cooked to prevent being burnt. For this purpose, the cooking container 110 was rotated to the left, and the agitation member 120 was also rotated to the left. Although not particularly limited, the rotational speed at this time is, for example, about 20 to 30 rpm. In the present embodiment, the shape of the agitation member 120 is designed so that the agitation member 120 scoops up the ingredients when it is rotated to the left. As shown in FIG. 15, by rotating the agitation member 120 to the left (in the forward rotation), the agitation member 120 agitates the ingredients along the inner surface shape of the cooking container 110. When the cooking container 110 and the agitation member 120 are both rotated in the same left rotational direction, the ingredients are easily scooped up by the agitation member 120, and thus the ingredients are easily agitated.

In addition, the cooking container 110 in the cooking posture is heated from the side surface by the container heating unit 132, but in the first cooking example, the cooking container 110 rotates to the left. Consequently, the part of the cooking container 110 where the ingredients come into contact with always changes, so that the ingredients can be appropriately heated while preventing the ingredients from being burnt on the inner surface of the cooking container 110. For example, by setting the rotational speed of the cooking container 110 to be slightly higher than the rotational speed of the agitation member 120 (for example, at about 1 to 3 rpm), the part of the cooking container 110 where the ingredients come into contact with can be constantly changed, so that it is easier to prevent the ingredients from being burnt.

In the case of stir-fried vegetables of the first cooking example, the cooking container 110 and the agitation member 120 are rotated both in the same left rotational direction. However, for example, in the case of cooking ingredients having a high viscosity, the cooking container 110 is rotated to the right and the agitation member is rotated to the left, so that the ingredients are hardly burnt.

The second cooking example shown in FIG. 16 is an example of cooking fried rice. In the second cooking example, both modes are used for cooking:
(1) a forward rotation mode in which the cooking container 110 is rotated to the left and the agitation member 120 is also rotated to the left, similarly to FIG. 15; and
(2) a reverse rotation mode in which the cooking container 110 is rotated to the left and the agitation member 120 is rotated to the right.

When cooking fried rice, in order to fry the rice into a crispy state, it is required to achieve a cooking motion similar to the motion of a cook shaking a pot. In order to do so, by providing a time zone for cooking in the reverse rotation mode, it is possible to reproduce the cooking motion of a cook shaking a pot. In addition, the following time zone may be provided:
(3) a right rotation mode in which the cooking container 110 is rotated to the right and the agitation member 120 is also rotated to the right.

Since the right rotation mode is more effective in reproducing motion of a cook more largely shaking a pot, the time zone of the right rotation mode can be adopted in the second cooking example to reproduce a variety of pot motions by a cook. In addition, since the reverse rotation mode and the right rotation mode reduce the contact time between the agitation member and the ingredients, it is also possible to reproduce, for example, how to stir rice like cutting when making sushi rice (rice seasoned with vinegar), and it is also effective, for example, when cooking sushi rice, Chirashi Sushi (vinegared rice with various ingredients, e.g., Kinshi Tamago (shredded egg crepe), raw fish pieces, and the like), or Maze Gohan (mixed rice). Although not particularly limited, the rotational speed in the second cooking example was set to about 60 rpm.

In the automatic cooking apparatus of the present embodiment, the combination of the rotational directions and the rotational speeds of the cooking container 110 and the agitation member 120 is optionally set, and for example, the following combinations are possible.
(a) Cooking container 110 being rotated to the left and agitation member 120 being rotated to the left;
(b) Cooking container 110 being rotated to the right and agitation member 120 being rotated to the left;
(c) Cooking container 110 being rotated to the left and agitation member 120 being rotated to the right;
(d) Cooking container 110 being rotated to the right and agitation member 120 being rotated to the right;
(e) Cooking container 110 and agitation member 120 being rotated at the same speed;
(f) Cooking container 110 being rotated at higher speed than agitation member 120;
(g) Cooking container 110 being rotated at lower speed than agitation member 120;
(h) Cooking container 110 being rotated to the right and agitation member 120 being stopped;
(i) Cooking container 110 being rotated to the left and agitation member 120 being stopped;
(j) Cooking container 110 being stopped and agitation member 120 being rotated to the right;
(k) Cooking container 110 being stopped and agitation member 120 being rotated to the left; and
(l) Cooking container 110 being stopped and agitation member 120 being stopped.

A variety of agitation cooking can be set by combining the above-mentioned operations (a) to (l), and therefore, according to the automatic cooking apparatus of the present embodiment, it is possible to reproduce the agitation cooking which reproduces the cooking technique by a cook.

### Second Embodiment

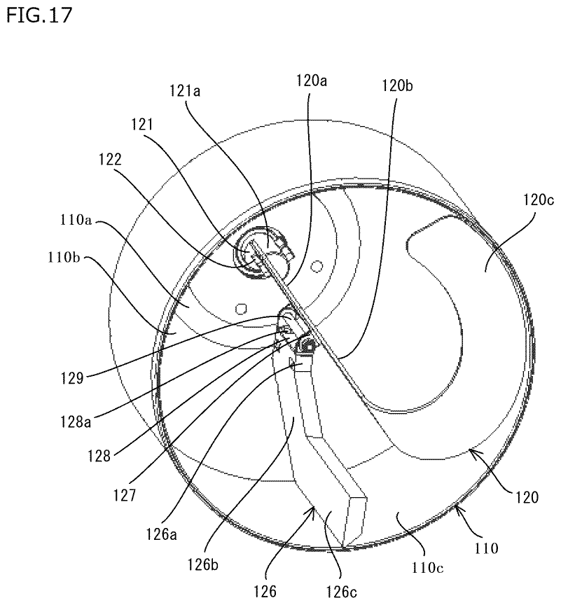

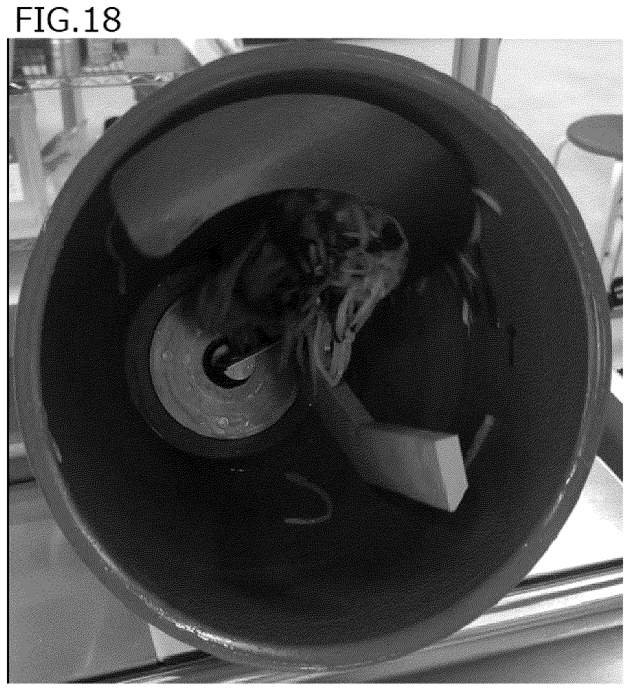

An automatic cooking apparatus according to a second embodiment of the present invention will be described with reference to FIGS. 17 to 20. The same components as those in the first embodiment are denoted by the same reference numerals, and descriptions thereof will be omitted. FIG. 17 is a perspective view of a cooking container 110 of the automatic cooking apparatus 100 according to the second embodiment of the present invention. In the present embodiment, by attaching a scraping member 126 to the agitation member 120, the dishing-up operation is performed more appropriately.

The scraping member 126 includes a base portion 126a, an inclined portion 126b, and a scraping portion 126c. An attachment member 128 is fixed to the base portion 126a by a screw 128a. On the other hand, an agitation member-side fixing portion 127 is attached to the straight portion 120b of the agitation member 120. The attachment member 128 is attached to the agitation member-side fixing portion 127 by a hinge 129 so that the scraping member 126 is freely rotatable with respect to the agitation member 120.

As the agitation member 120 rotates, the scraping member 126 rotates in the same direction together with the agitation member 120. When the agitation member is rotating to the left (in the forward direction), the scraping member 126 is movable by its own weight, but when the agitation member rotates in the forward direction, the food scraping function from the cooking container 110 is not exerted. On the other hand, when the agitation member is rotating to the right (in the reverse direction), the scraping member 126, in addition to being movable by its own weight, is rotated while the outer surfaces of the inclined portion 126b and the scraping portion 126c are in contact with the inclined surface portion 110b and the side surface portion 110c of the cooking container 110, respectively. Consequently, the food in the cooking container 110 is pushed out by the scraping portion 126c, and is scraped out to the dishing-up container D. At this time, the angle formed by the inclined portion 126b and the straight portion 120b is determined by a position where the scraping portion 126c is in contact with the side surface portion 110C, a position where the hinge 129 is attached to the straight portion 120b, and a position where the straight portion 120b is in contact with the inclined surface portion 110b.

Furthermore, in a state where the agitation member 120 is in a stationary state, even when only the cooking container is rotated to the left, the cooking container 110 is rotated in a state where the outer surfaces of the inclined portion 126b and the scraping portion 126c are in contact with the inclined surface portion 110b and the side surface portion 110c of the cooking container 110, respectively. Consequently, the food in the cooking container 110 is pushed out by the scraping portion 126c, and is scraped out to the dishing-up container D.

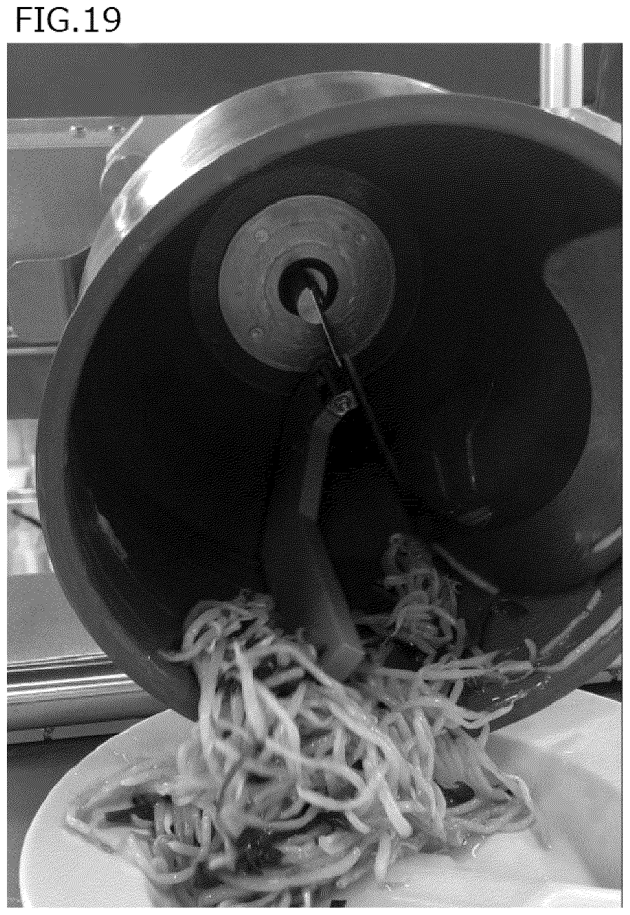

Next, a cooking example of the present embodiment will be described with reference to FIGS. 18 to 20.

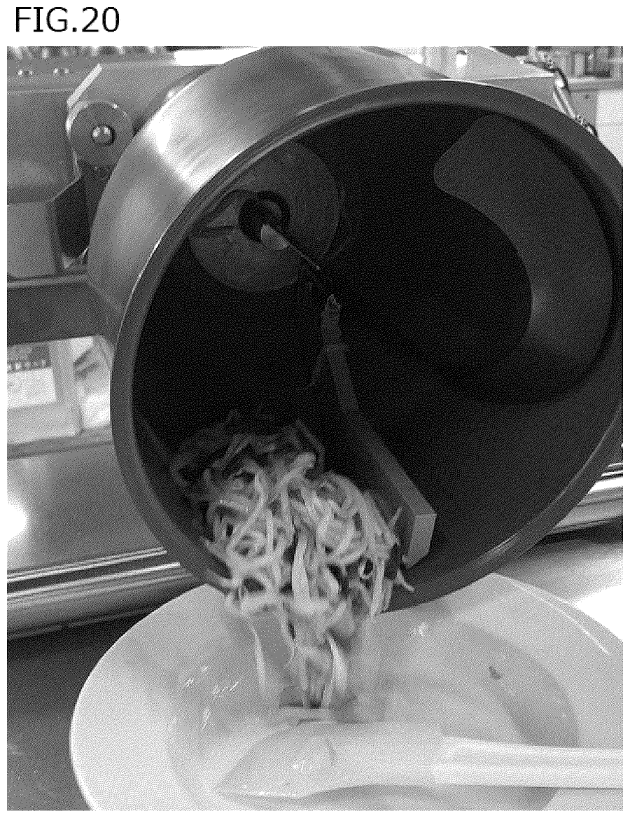

FIG. 18 shows a cooking example of the automatic cooking apparatus 100 illustrated in FIG. 17, FIG. 19 shows a first dishing-up operation example of the automatic cooking apparatus 100 illustrated in FIG. 17, and FIG. 20 shows a second dishing-up operation example of the automatic cooking apparatus 100 illustrated in FIG. 17.

FIG. 18 shows the cooking example in which the agitation member 120 to which the scraping member 126 was attached was used to perform stir-frying. The cooking container 110 was rotated to the left, and the agitation member 120 was also rotated to the left. In this case, as in the first cooking example of the first embodiment, by rotating the agitation member 120 to the left (in the forward rotation), the agitation member 120 agitates the ingredients along the inner surface shape of the cooking container 110. When the cooking container 110 and the agitation member 120 are both rotated in the same left rotational direction, the ingredients are easily scooped up by the agitation member 120, and thus the ingredients are easily agitated. When the agitation member 120 is rotated to the left, the scraping member 126 is swung by its own weight, but does not affect the agitating state of the ingredients.

FIG. 19 shows a first dishing-up example when the food was dished up while the scraping member 126 was rotationally driven. The cooking container 110 was rotated to the left and the agitation member 120 was rotated to the right. As described above, when the agitation member 120 is rotated to the right (in the reverse rotation), the scraping member 126 is rotated while the outer surfaces of the inclined portion 126b and the scraping portion 126c are in contact with the inclined surface portion 110b and the side surface portion 110c of the cooking container 110, respectively, at an angle determined between the scraping portion 126c, the hinge 129, and the linear portion 120b. Consequently, the food in the cooking container 110 is pushed out by the scraping portion 126c, and is scraped out to the dishing-up container D. In the first dishing-up example, the agitation member 120 was caused to rotate to the right (not particularly limited, for example, at about 10 to 20 rpm) during dishing-up while the cooking container 110 was rotated to the left at a low speed (not particularly limited, for example, at about 1 to 3 rpm). In the first dishing-up example, the dishing-up is possible without rotating the cooking container 110. However, in the case where dishing-up is performed when the cooking container 110 is in a stationary state, food sticking on the inner surface of the cooking container 110 positioned above may not be scraped out, and thus, in the case of cooking with a high viscosity, in particular, it is preferable to perform the dishing-up operation while rotating the cooking container 110 to the left.

FIG. 20 shows a second dishing-up example in the case where dishing-up was performed while the scraping member 126 was stopped. The cooking container 110 was rotated to the left (for example, but not limited to, at about 10 to 20 rpm), and the agitation member 120 was stopped. In this case, since the force in the right rotational direction relative to the circumferential surface of the cooking container 110 is applied to the scraping member 126, the outer surfaces of the inclined portion 126b and the scraping portion 126c are in contact with the inclined surface portion 110b and the side surface portion 110c of the cooking container 110, respectively, at an angle determined by the scraping portion 126c, the hinge 129, and the linear portion 120b. Consequently, the food in the cooking container 110 is pushed out by the scraping portion 126c and is scraped out to the dishing-up container D. In the second dishing-up example, while the cooking container 110 is primarily rotated to the left, there are time zones where the cooking container 110 momentarily rotates to the right instead of continuously rotating to the left. Consequently, this helps scrape out the food, preventing it from sticking onto the entire circumference of the cooking container 110.

### Modification

The above-described embodiments exemplify the automatic cooking apparatus for embodying the technical idea of the present invention, and the present invention is not limited thereto. The present invention may be equally applied to other embodiments, such as those obtained by modifying the present embodiment and those obtained by combining the respective technologies described in the present embodiment.

For example, in the above-described embodiment, the agitation member is provided on the bottom surface of the cooking container, but the agitation member is not necessarily provided on the bottom surface portion of the cooking container, and it is also possible to insert the agitation member from the opening surface side. Furthermore, although the cooking container 110 has been described as having the bottom surface portion 110a, the inclined surface portion 110b, and the side surface portion 110c, the shape of the cooking container 110 may be any optional shape as long as it has a bottomed cylindrical shape. For example, the shapes of the bottom surface portion 110a, the inclined surface portion 110b, and the side surface portion 110c may be hemispherical or conical.

For example, the arrangement of the respective devices in the embodiments of the present invention is not limited to those shown in the drawings, and the respective devices may be displaced to the right and left and the front and rear. For example, the arrangement of the operation panel 171 and the power supply cord 180 is arbitrarily set, and is not limited to the one illustrated in the drawings.

For example, in the above-described embodiments, the washing unit 160 washes the cooking container 110 with washing water, but the method for washing the internal surface of the cooking container 110 is not limited to those with water. Furthermore, in the above-described embodiments, the automatic cooking apparatus 100 includes the washing unit 160, but the washing unit 160 may be separately provided from the automatic cooking apparatus 100. When the washing unit 160 is separately provided from the automatic cooking apparatus 100, the automatic cooking apparatus 100 and the washing unit 160 are controlled by a control device that controls each of the behavior of the automatic cooking apparatus 100 and the behavior of the washing unit 160.

For example, in the above-described embodiments, examples have been described in which the cooking container 110 is rotationally driven in a state where the scraper 162a is pushed against the inner surface of the cooking container 110. However, there may be provided a mechanism that is driven so as to reciprocate along the inner surface of the cooking container 110 in a state where the scraper 162a is pushed against the cooking container 110. In this instance, residues inside the cooking container 110 can be scraped off by driving only the scraper 162a or by both the rotary driving of the cooking container 110 and the driving of the scraper 162a.

For example, in the above-described embodiments, the heating device of the container heating unit 132 is not limited to the IH heater 132a, and any optional heating device can be applied as long as the temperature can be controlled. Examples thereof may include a radiant heater that heats the cooking container by an electric heating wire, and a sheathed heater.

For example, in the above-described embodiments, examples have been described in which the control unit 170 automatically executes all the controls of the automatic cooking apparatus 100 in accordance with the cooking content based on the input from the operation panel 171. However, it is also possible to replace a part of the control set by the control unit 170 with an input instruction from an operator. Furthermore, instead of automatically performing all of the cooking operations by the automatic cooking apparatus 100, some of the cooking operations may be manually or semi-automatically performed. For example, at the time of dishing-up the food, it is possible for an operator to manually arrange the dishing-up of food from a design point of view. In addition, the automatic cooking apparatus 100 can be controlled independently without connecting the control unit 170 to an external network 178.

1-7. (canceled)

8. An automatic cooking apparatus comprising: a bottomed cylindrical cooking container; and a container holding unit configured to hold the cooking container, the automatic cooking apparatus being configured to perform, at a minimum, agitation and cooking of an ingredient contained in the cooking container, wherein:
the cooking container includes an agitation member configured to agitate the ingredient;
the container holding unit includes a container rotation mechanism configured to cause the cooking container to rotate around a container rotation shaft;
the agitation member is driven from the bottom surface of the cooking container;
when a motional state of the cooking container including a rotational direction, a rotational speed, or a stationary state is a first motional state, the agitation member is allowed to take a second motional state that does not depend on the first motion state of the cooking container;
the container holding unit includes an agitation member drive mechanism configured to rotationally drive the agitation member, and the agitation member drive mechanism is capable of setting the motional state of the agitation member to the second motional state different from the first movement state of the cooking container by the container rotation mechanism; and
when an operational state of the cooking container is a right rotation, a left rotation, or a stationary state, the agitation member drive mechanism is capable of setting an operational state of the agitation member to any state of a right rotation, a left rotation, or a stationary state.

9. The automatic cooking apparatus according to claim 8, wherein the agitation member further includes a scraping member configured to scrape food cooked by the automatic cooking apparatus in accordance with an operational state of the agitation member and/or the cooking container.

10. The automatic cooking apparatus according to claim 8, wherein a posture of the cooking container is allowed to be changed to any one of postures including:
(1) an ingredient receiving posture for having the cooking container receive the ingredient;
(2) a cooking posture for having the cooking container be rotated by the container rotation mechanism to cook the ingredient;
(3) a dishing-up posture in which the cooking container is caused to face downward to a dishing-up container; and
(4) a washing posture for washing the cooking container with an opening side of the cooking container facing downward.

11. The automatic cooking apparatus according to claim 10, wherein when the cooking container is in the washing posture, the cooking container is washed by bringing a scraper into contact with an inner surface of the cooking container.

12. The automatic cooking apparatus according to claim 11, wherein
when the cooking container is in the washing posture,
the cooking container is placed in at least one washing state out of:
a washing state where the scraper is brought into elastic contact with the inner surface of the cooking container;
a washing state where the scraper is driven in a state where the scraper is in contact with the inner surface of the cooking container; and
a washing state where the cooking container is caused to rotate in a state where the scraper is in contact with the inner surface of the cooking container.
